(19) United States
(12) Patent Application Publication
(10) Pub. No.: US 2009/0292509 A1
(43) Pub. Date: Nov. 26, 2009

(54) METHOD AND SYSTEM FOR ASSESSING RESPONSE OF A BUILDING SYSTEM TO AN EXTREME EVENT

(76) Inventors: Benjamin P. Thompson, Middleton, WI (US); Lawrence C. Bank, Washington, DC (US)

Correspondence Address: WISCONSIN ALUMNI RESEARCH FOUNDATION, C/O BOYLE FREDRICKSON S.C, 840 North Plankinton Avenue, Milwaukee, WI, 53203, US

(21) Appl. No.: 12/465,992

(22) Filed: May 14, 2009

Related U.S. Application Data
(60) Provisional application No. 61/055,544, filed on May 23, 2008.

(51) Int. Cl. G06F 17/50; G06F 15/18; G06G 7/48

(52) U.S. Cl. 703/1; 706/12; 703/6

(57) ABSTRACT

A method for assessing the impact of a disrupting event on a structure, such as building, vis-à-vis its multiple interrelated systems as well as the occupants of the structure is disclosed. The method, which may be embodied in computer readable code stored on a computer readable storage medium and executable by a computer or similar workstation, can be applied to structures that are in the design phase, construction phase, as well as the post-construction phase. The invention allows the impact of a disrupting event, including the response of building occupants to the disrupting event, to be simulated and assessed from infancy and throughout the life of the structure, and used to assess various design alternatives when allocating resources.

### CROSS-REFERENCE TO RELATED APPLICATION

The present application claims the benefit of U.S. Ser. No. 61/055,544, the disclosure of which is incorporated herein by reference.

### STATEMENT REGARDING FEDERALLY SPONSORED RESEARCH

This invention was made with United States government support awarded by the following agencies:
DHS/ST 2007-ST-061-000001

The United States government has certain rights in this invention.

### FIELD OF THE INVENTION

This invention relates generally to design and modeling of buildings and similar structures in which the response of the structure, including that of its occupants, to a disrupting or extreme event, such as a terrorist attack or natural disaster, is simulated. The invention is believed to be particularly useful in resource allocation between the various interrelated systems of the building to optimize response to different types of disrupting events.

### BACKGROUND AND SUMMARY OF THE INVENTION

Recently there has been a renewed emphasis on assessing the response of a building, its various interrelated systems, and its occupants to a significant disruption, including natural disasters such as earthquakes and hurricanes, as well as other types of events, such as fire and terrorism. Historically, this type of analysis has required evacuation drills and similar real-world simulations. For a large structure such as a multi-floor office building, conducting such real-world simulations is impractical and is generally considered an unwelcomed interruption by building personnel, especially when such simulations or drills are repeated.

As a result, many researchers have conducted small-scale real world simulations to determine a general response to a given disruption. For example, studies have been conducted to determine how many people can traverse a hallway or a staircase in a given period of time. That information then can be used to estimate how many people could exit a building if a mass evacuation is required. Security and emergency response personnel also use such information to develop appropriate evacuation and response plans.

The information provided from the aforementioned studies has been helpful in improving response to a potentially catastrophic event and building designers and architects now consider such information when designing an office building, warehouse, mall, arena, or similar densely occupied structure. Similarly, building codes increasingly take into consideration such factors when prescribing size of doorways, hallways, etc. Nevertheless, the usefulness of the information can be limited because it is building specific and it is not integrated with the various systems of the building. That is, the data provided by the model for the number of people that can successfully exit a building in response to a disruption does not generally consider the impact the disruption will physically have on the people. To assess the impact of a harmful agent introduced into a building, information regarding physiological response of the occupants to the agent, information regarding how the contaminated air is circulated throughout the building, information as to how the air is filtered by any air filtration system in the building, as well as how quickly occupants can be evacuated from the building, and feedback loops describing how the preceding information affects the speed of egress are just a few of the factors that may be considered when designing the physical structure of the building, including the number of exits, width of hallways/doorways, type of HVAC system, etc. Currently, coalescing such information can be difficult and, moreover, is generally building independent, and often fails to incorporate feedback loops in its analysis.

The present invention is directed to a method for assessing the impact of a disrupting event on a structure, such as building, vis-à-vis its multiple interrelated systems, as well as the occupants of the structure. The inventive method, which may be embodied in computer readable code stored on a computer readable storage medium and executable by a computer or similar workstation, can be applied to structures that are in the design phase, construction phase, as well as the post-construction phase. In this regard, the impact of a disrupting event can be simulated and assessed from infancy and throughout the life of the structure.

### BRIEF DESCRIPTION OF THE DRAWINGS

The drawings furnished herewith illustrate a preferred construction of the present invention in which the above advantages and features are clearly disclosed, as well as others which will be readily understood from the following description of the illustrated embodiment.

In the drawings:

FIG. 1 is an schematic elevation of an office building whose response to a stimulus may be modeled and analyzed using one embodiment of the present invention;

FIG. 2 is a flow chart of a process for evaluating building and occupant response to a disruption according to one embodiment of the present invention;

FIG. 3 is schematic representation of a building information model for a floor of the office building represented in FIG. 1;

FIG. 4 is an egress model for the building information model of FIG. 2 comprised of structural information and occupant flow rate information according to an embodiment of the invention;

FIG. 5 is an air flow model for the air circulation system of a building according to another embodiment of the present invention; and

FIG. 6 is a schematic representation of a computerized system capable of executing computer readable code to assess behavior of a computerized model to an applied stimulus, such as a disruptive event, according to the present invention.

### DETAILED DESCRIPTION OF THE DRAWINGS

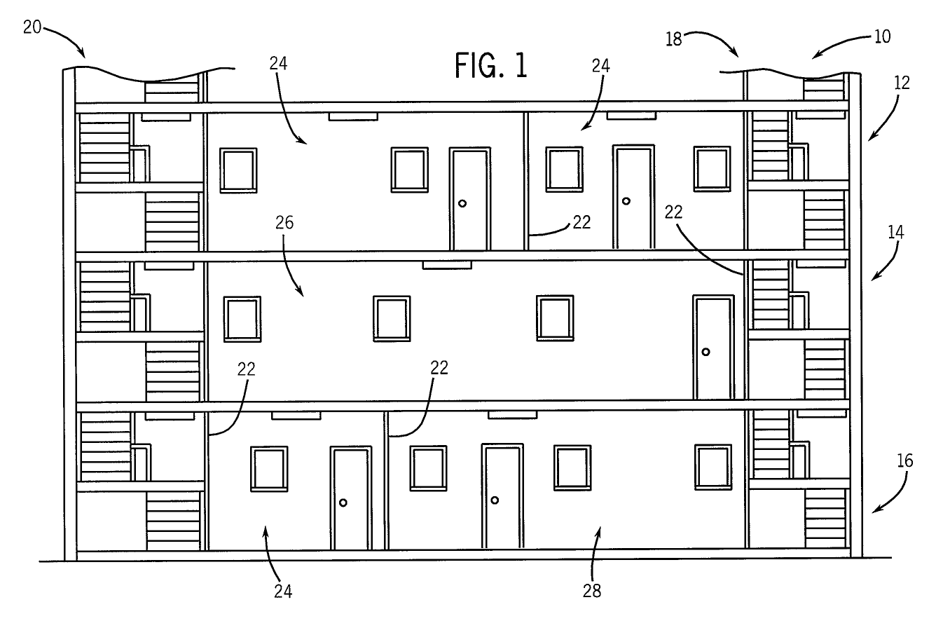

Referring to FIG. 1, a portion of an office building 10 is schematically illustrated as having three floors, generally represented by reference numerals 12, 14, and 16. The illustrated building 10 contains two stairwells 18 and 20 situated at opposite sides of the office building 10 and accessible at each floor by doors (not shown). In the illustrated building 10, each floor 10, 12, 14 is partitioned by walls 22 into offices 24, hallways 26, and conference rooms 28 in a known manner. It is understood that the building 10 may be partitioned in a different manner and, in this regard, the invention is not limited to any particular building or building layout.

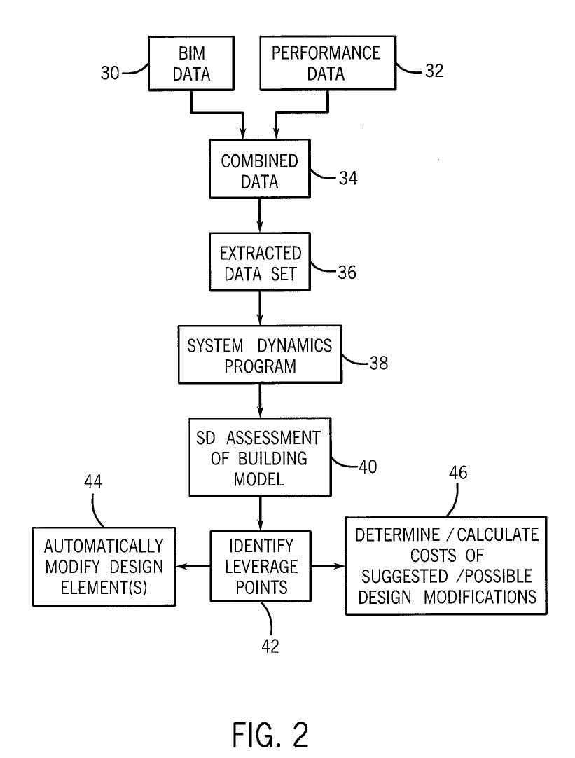

As will be described more fully below, the present invention synthesizes building model information for a building, such as building 10, with occupant response information and performs a systems dynamics assessment of the synthesized information. Referring now to FIG. 2, the building information model data, generally represented by database 30, is augmented with occupant and building sub-system response information, generally represented by database 32. This data is combined to provided a combined dataset 34. Data associated with the systems of the building whose response to an extreme event is to be evaluated, e.g., building 10, is extracted from the combined dataset 34 to provide an extracted dataset 36. The extracted data 36 is then input to a systems dynamics program 38 that simulates a disruption(s) to the modeled building and its modeled occupants. Using feedback from the various systems, a system dynamics assessment 40 allows an engineer, designer, risk assessment personnel, and the like to identify key leverage points 42 to optimize response to the simulated disruption and determine allocation of resources. That is, the leverage points represent those components of the building where a judicious use of resources can be used to mitigate the effects of the disruption, such as revising the structural composition or spatial configuration of the building, for example. In addition to identifying leverage points, elements of the building model can be automatically modified within certain design constraints as illustrated at block 44. Cost information associated with suggested or possible design modifications may be determined using general cost data stored in an accessible database, whether local or remote, and displayed at block 46.

One skilled in the art will appreciate that extracting the pertinent data from the augmented data reduces the computational load on the system dynamics program as data unrelated to building (or system) response to the simulated extreme event is not considered in the assessment.

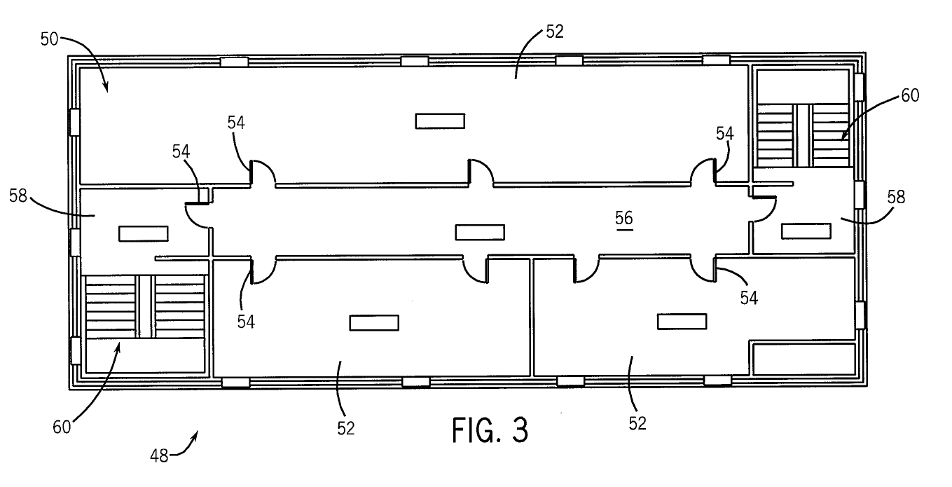

FIG. 3 schematically illustrates a building information model 48 for a floor 50 of a building 10. As appreciated by one skilled in the art, building information model 48 provides a schematic layout of the floor 50, thereby providing a geometric or spatial relationship between the various structural components of the floor, such as rooms 52, doors 54, hallways 56, landings 58, and stairwells 60. In addition to providing a graphical layout of the floor, the building information model 48 also includes one or more databases, as described above, that contain the raw data from which the graphical model is derived. This raw data includes dimensional information for the rooms, hallways, doors, etc. In this regard, the building information model provides data regarding the composition of the building and not information as to how the building, or its systems, which includes any occupants, would respond to an extreme event.

Therefore, as described with respect to FIG. 2, the data of the building information model 48 is augmented with generalized performance or response data for the various components of the building. For example, to measure how the layout of the floor affects egress of any occupants in response to an extreme event, the building information model data is augmented with data related to how many people can fit through a doorway, how many people can fit on a landing, how quickly people can climb down a set of stairs, etc. A system dynamics model may then be generated from the pertinent building information model data and the augmented data.

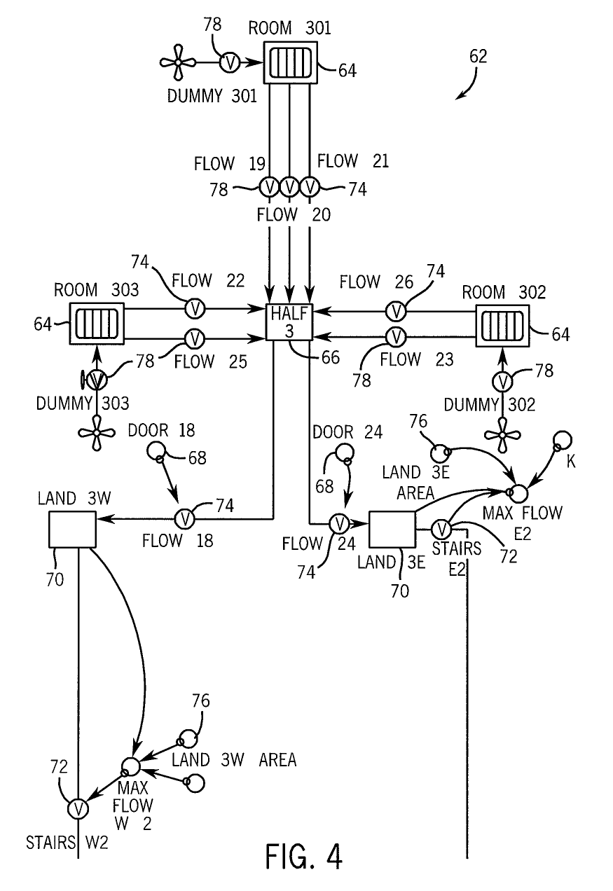

As graphically shown in FIG. 4, a system dynamics model may include information derived from the building information model 48 pertaining to the layout of a particular floor 50 of the building. In this regard, the system dynamics model includes extracted components of the building information model whose response to an extreme event impacts overall building response to the extreme event. The system dynamics layout 62 of the floor contains objects that correspond to the various structural, i.e., static components of the floor, such as rooms 64, hallway 66, doors 68, stairwell landings 70, and stairs 72. As described above, the system dynamics model also contains data related to various performance or response parameters, such as occupant flow rate 74, room and stairwell capacity 76, etc. To measure egress from the floor in response to air quality issues, such as injection of a potentially fatal gas, occupant room-to-room flow rate 78 as well as occupant physiological response to the contaminated air may also be included in the system dynamics model. This combined building data and response/performance data may then be used in a system dynamics assessment to identify how many occupants, for example, may be able to exit the building over various time intervals. During the design stage, the results may indicate that more stairwells or wider hallways and doorways are needed. For an erected building, such information may be used to place occupancy limits on the building or implement an air quality system that reduces the flow of contaminated air throughout the building. In one preferred embodiment, when a design change is made, such as expansion of the hallways, addition of

a stairwell, or improved (or new) air quality system, the system dynamics assessment is re-performed to gauge the impact of the change.

For example, the table below lists various parameters that may be varied to assess performance of a building or a portion of the building such as a floor, in response to injection of an air contaminant.

| | | | | | | |
|---|---|---|---|---|---|---|
| Building | Floor Area | Floor Height | Number of | Ingress/Egress | Detection/ | Stairway Width |
| Design | | | Zones | Rates | Alarm | |
| Parameters | | | | | System | |
| Building | Outside Air | Filter | UVGI | Occupant | Signage | Communication |
| Operation | Fraction | Efficiency | Efficiency | Training | | System |
| Parameters | | | | | | |

In one embodiment, the data of the building information model is augmented with generalized system performance data before systems having an impact on overall building response to a disrupting event are identified. In another embodiment, the data augmentation is carried out after the systems have been identified. In either case, the disrupting event will be used to determine how the building information model data is augmented. In this regard, the performance data that is used to augment the building information model data may change as different extreme events are evaluated.

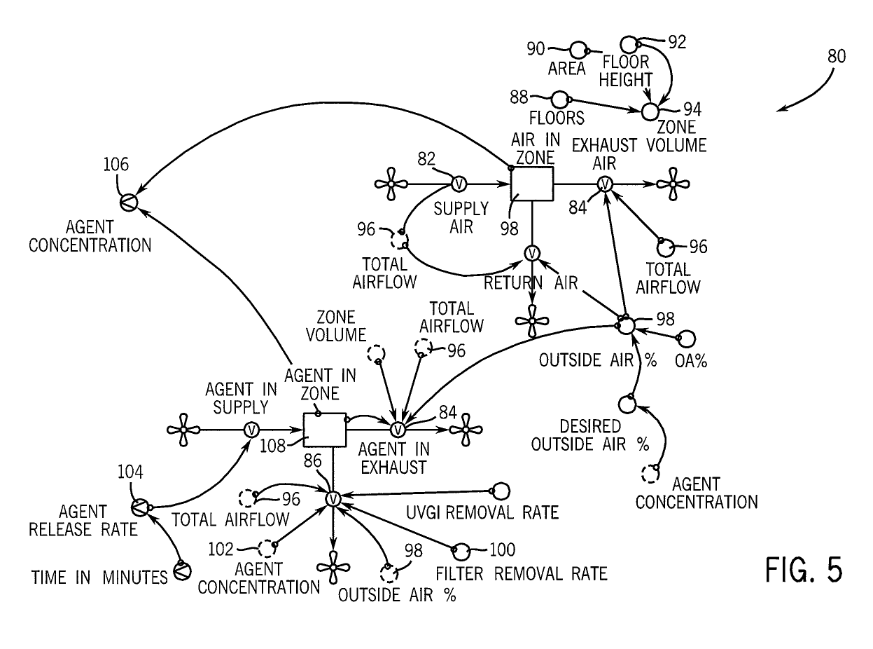

In another example, the air circulation system of the building could be modeled and its performance simulated, such as illustrated in FIG. 5, to determine what changes in the air circulation/ventilation system are needed to improve response to injection of a harmful agent into the system. The system dynamics model of the critical systems includes information regarding the physical composition of the air circulation system 80, such as air intake ports 82, air exhaust ports 84, and air filtration system 86, as well as structural information, such as number of floors 88, area 90, and floor height 92. This information defines the air volume 94 of the building. This static information may be augmented with information for other parameters that would impact the performance of the air circulation system 80 if a harmful agent was introduced. For instance, the model may include air flow data 96, outside air intake data 98, and filtration rate data 100, among other parameters. A system dynamics assessment may then be performed on the combined data to assess performance of the air circulation system in response to introduction of air contaminates 102. In this regard, for a given concentration of agent 102 at a defined release rate 104, the concentration of the agent 106 in a given zone 108, or the building as a whole, may be simulated over time to assess how the agent is passed throughout the building. Based on the results, resources can be smartly allocated to reduce the impact of the injected contaminants.

Moreover, the performance data of the air circulation system may be repeatedly modeled to assess performance of the individual system components. For example, the system dynamics program may output a simulated bio-agent concentration and a simulated fatalities number under three different scenarios for a given injection of a bio-contaminate. In a representative first case, baseline values may be derived without any filtration and independent of the percentage of outside air drawn into the building. In a representative second case, values may be derived with air filtration but without consideration of the outside air concentration, and in a representative third case, values may be derived that take into account both air filtration and the percentage of outside air that is introduced into the building, or portion thereof. Evaluation of these different scenarios enables an engineer or designer to measure the impact the various components of the air circulation system have on overall building response. For instance, the data may show that the expected concentration of contaminant and expected fatality rate is relatively the same for the second and third cases. As a result, the building, or system designers, may therefore conclude that resources need not be allocated to drawing more outside air into the building if a bio-agent is released in the building.

One of the advantages of the present invention is that multiple building systems can be modeled and augmented with “dynamic” data to simulate the impact a disruption may have on the building as a whole or portion thereof. For example, a terrorist attack on a building may include structural damage, injection of poisonous agents into the air circulation system, and explosions that result in fire to the building. To assess the response of the building to such an attack would preferably include an assessment of the air circulation and filtration system, fire retardant properties of building materials, occupant egress, in-building sprinkler system, and occupant physiological response to the poisonous agent and smoke. From a combined system dynamics assessment, the interrelatedness of the building systems can be evaluated and ultimately leverage points identified to maximize the number of occupants that exit the building and minimize the number of injuries and fatalities.

It is also contemplated that design changes to a given model may be automated based on the results of the system dynamics assessment. The automation would recognize those systems, or components, that have the greatest impact on the response to a disruption and make/propose design modifications accordingly. It is understood that the design choices may be limited based on several factors, such as cost, code requirements, aesthetic requirements, environmental concerns, etc.

One skilled in the art will appreciate that a given structure, such as a building, is composed of a number of components that can be categorized into a number of systems. For example, material composition of the various physical structures may be characterized as the structural system of the building. The spatial or geometric layout of the building may be characterized as a separate system. Those components related to air flow throughout the building may be considered the ventilation system. The occupants of the building may also be considered as a separate system of the building. The present invention provides a useful tool to assess how one or more of these systems for a specific building responds to a disrupting event and provides an effective tool for determining where resources should be allocated to mitigate the impact of the event on the building as a whole.

In addition, it is contemplated that the present invention can be embodied in a stand-alone risk assessment computer program or integrated with a building information modeling software program.

While the invention has been described with respect to a building, such as an office building, it is understood that the invention is also applicable with various types of structures including office buildings, arenas, stadiums, schools, hospitals, malls, manufacturing plants or facilities, depots, refineries, and similar densely occupied structures as well as airplanes, trains, cruise liners and the like. It is also contemplated that the invention could be used to assess the performance or response of quasi-earthen structures, such as a mine, to a stimulus.

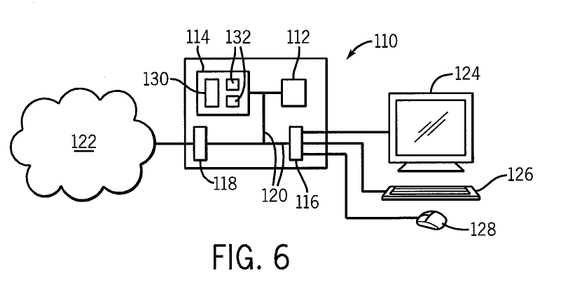

Referring now to FIG. 6, a typical computer system 110 suitable for use with the present invention may provide a processor 112 communicating with a memory 114 and with interfaces 116 and 118 via an internal bus 120. Interface 116 may provide for connections to a display monitor 124 and one or more input devices including keyboard 126 and cursor control device 128 such as a mouse. Interface 118, for example, may be a standard Ethernet interface communicating with the Internet 122. Such a computer system 110 represents a typical work station of a type well known in the art.

The memory 114 of the computer system 110 may hold an operating system kernel 130, for example, the Windows operating system manufactured by Microsoft of Redmond Calif. As is generally understood in the art, the kernel 130 is a computer program that provides an interface between the hardware of the computer system 110 and one or more application programs 132, for example, a computer program(s) that performs the modeling and system dynamics assessment described herein, running on the computer system 110. It is understood that other types of computer systems may be used to perform the method described herein.

Various modes of carrying out the invention are contemplated as being within the scope of the following claims, particularly pointing out and distinctly claiming the subject matter which is regarded as the invention.

We claim:

1. A method comprising:
accessing a computerized model of a building, the building including a number of systems and the computerized model including static data regarding a number of systems;
augmenting the static data with generic performance data regarding performance of one or more of the building systems;
performing a system dynamics assessment of one or more systems of the building to measure response of the one or more systems to a specific stimulus; and
determining an impact a system had on overall building response to the stimulus from the system dynamics assessment.

2. The method of claim 1 wherein the performing a system dynamics assessment is carried out with the building in a pre-construction phase.

3. The method of claim 1 wherein the performing a system dynamics assessment is carried out with the building in a post-construction phase.

4. The method of claim 1 further comprising automatically updating the computerized model based on the impact of the system.

5. A computerized apparatus for assessing response of a building and its systems to an event, the computerized apparatus comprising a computer adapted to execute executable commands contained in code stored on a computer readable medium, wherein the executable commands cause the computer to:
acquire first data from a building information model of the building;
determine second data relating to expected performance of the building systems;
combine the first data and the second data into a third data;
perform a system dynamics assessment of the third data; and
provide a computerized output from the system dynamics assessment indicating whether response of the systems to a simulation of the event satisfied desired response targets.

6. The computerized apparatus of claim 5 wherein computer is further caused to automatically modify elements of the building information model based on whether the response satisfied the desired response targets.

7. The computerized apparatus of claim 5 wherein the first data corresponds to dimensional information for at least a portion of the building modeled in the building information model.

8. The computerized apparatus of claim 7 wherein the second data corresponds to quantification of occupant response to a specified event.

9. The computerized apparatus of claim 5 wherein the event is a simulated terrorist attack on the building.

10. The computerized apparatus of claim 9 wherein the simulated terrorist attack includes a simulated bioterrorism act.

11. The computerized apparatus of claim 5 wherein the building information model is of a building yet to be physically constructed or of an existing building.

12. A computerized design tool for modeling a structure and assessing performance of the model to provide a framework for the allocation of resources, the tool comprising:
first computer executable code stored on a computer readable storage medium that when executed by a computer causes the computer to allow a user to design and model a structure designed to contain individuals;
second computer executable code stored on the computer readable storage medium that when executed by a computer causes the computer to associate generic response data of an occupant to a specified event; and
third computer executable code stored on the computer readable storage medium that when executed by a computer causes the computer to simulate an event and perform a system dynamics assessment of the building and a simulated number of occupants in response to the simulated event.

13. The computerized design tool of claim 12 further comprising fourth computer executable code stored on the computer readable storage medium that when executed by a computer causes the computer to automatically identify potential design modifications of the model based on results of the system dynamics assessment.

14. The computerized design tool of claim 13 wherein the model includes cost information and wherein the fourth computer executable code further causes the computer to provide a computerized output indicative of an estimated cost for each potential design modification.

15. The computerized design tool of claim 13 further comprising a database containing generalized response information of an occupant to various types of events.

16. The computerized design tool of claim 12 wherein the simulated event is a terrorism event.

17. The computerized design tool of claim 12 wherein the structure is a man-made structure.

18. The computerized design tool of claim 17 wherein the man-made structure is a building.

19. The computerized design tool of claim 12 wherein the first computer executable code, the second computer executable code, and the third computer executable code are contained within a single software suite.
